(19) United States
(12) Patent Application Publication
(10) Pub. No.: US 2022/0198592 A1
(43) Pub. Date: Jun. 23, 2022

(54) INNOVATION LIFE CYCLE SYSTEM PLATFORM

(71) Applicant: SAE International, Warrendale, PA (US)

(72) Inventor: Raman Venkatesh, Wexford, PA (US)

(21) Appl. No.: 17/126,232

(22) Filed: Dec. 18, 2020

(51) Int. Cl. G06Q 50/18; G06Q 40/06; G06Q 30/02

(52) U.S. Cl. CPC G06Q 50/184; G06Q 30/0201; G06Q 40/06

(57) ABSTRACT

One embodiment provides a method for facilitating an innovation life cycle by connecting stakeholders utilizing an analysis for identifying best stakeholder matches and facilitating innovation transactions, the method including: receiving, at a system platform, information corresponding to an innovation from a first stakeholder; ranking, using the system platform, the innovation based upon a likeliness of commercial success of the innovation, the likeliness being determined based upon a plurality of factors corresponding to the innovation and identified, at least in part, from the information; identifying, using the system platform, at least one second stakeholder for performing an objective evaluation of the innovation, wherein the at least one second stakeholder comprises an expert suitable for analyzing the innovation; and facilitating, via the system platform, an innovation transaction between the first stakeholder and at least one third stakeholder, wherein the at least one third stakeholder initiates the innovation transaction in response to receipt of the objective evaluation. Other aspects are described and claimed.

### BACKGROUND

It can be very difficult to gain a foothold in the marketplace without recognition by consumers. Thus, when a start-up company is attempting to gain a foothold in the marketplace, it generally needs an infusion of money, expertise, relationships with market leaders, and/or the like. For example, a start-up company may need an infusion of money in order to bring an innovation to market and advertise the product so that consumers start to recognize the product and purchase it. As another example, some market categories are very competitive and having a relationship with a market leader either directly or indirectly would provide the boost that a start-up needs in order to become competitive in the category.

On the other side, investors, experts, market leaders, and/or the like, are contacted by many different innovators and start-up companies wanting access to money, expertise, connections, and/or the like. Since these people are inundated with many different requests, very few of these requests get second looks or a more detailed analysis by the people or team of people. Generally, the requests that do receive attention from these people are requests from start-ups or innovators that already have a market share, have previous financial backing, have proven success, or the like. For the investors, experts, market leaders, and/or the like, these requests have a lower amount of risk associated with them and, therefore, are more attractive for investing time, money, contacts, or the like, than a start-up or innovation without such things.

### BRIEF SUMMARY

In summary, one aspect provides a method for facilitating an innovation life cycle by connecting stakeholders utilizing an analysis for identifying best stakeholder matches and facilitating innovation transactions, the method including: receiving, at a system platform, information corresponding to an innovation from a first stakeholder; ranking, using the system platform, the innovation based upon a likeliness of commercial success of the innovation, the likeliness being determined based upon a plurality of factors corresponding to the innovation and identified, at least in part, from the information; identifying, using the system platform, at least one second stakeholder for performing an objective evaluation of the innovation, wherein the at least one second stakeholder comprises an expert suitable for analyzing the innovation; and facilitating, via the system platform, an innovation transaction between the first stakeholder and at least one third stakeholder, wherein the at least one third stakeholder initiates the innovation transaction in response to receipt of the objective evaluation.

Another aspect provides a system for facilitating an innovation life cycle by connecting stakeholders utilizing an analysis for identifying best stakeholder matches and facilitating innovation transactions, the system including: one or more processors; a memory device that stores instructions executable by the processor to: receive, at a system platform, information corresponding to an innovation from a first stakeholder; rank, using the system platform, the innovation based upon a likeliness of commercial success of the innovation, the likeliness being determined based upon a plurality of factors corresponding to the innovation and identified, at least in part, from the information; identify, using the system platform, at least one second stakeholder for performing an objective evaluation of the innovation, wherein the at least one second stakeholder comprises an expert suitable for analyzing the innovation; and facilitate, via the system platform, an innovation transaction between the first stakeholder and at least one third stakeholder, wherein the at least one third stakeholder initiates the innovation transaction in response to receipt of the objective evaluation.

A further aspect provides a product for facilitating an innovation life cycle by connecting stakeholders utilizing an analysis for identifying best stakeholder matches and facilitating innovation transactions, the product including: a storage device that stores code, the code being executable by one or more processors and comprising: code that receives, at a system platform, information corresponding to an innovation from a first stakeholder; code that ranks, using the system platform, the innovation based upon a likeliness of commercial success of the innovation, the likeliness being determined based upon a plurality of factors corresponding to the innovation and identified, at least in part, from the information; code that identifies, using the system platform, at least one second stakeholder for performing an objective evaluation of the innovation, wherein the at least one second stakeholder comprises an expert suitable for analyzing the innovation; and code that facilitates, via the system platform, an innovation transaction between the first stakeholder and at least one third stakeholder, wherein the at least one third stakeholder initiates the innovation transaction in response to receipt of the objective evaluation.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example method for facilitating an innovation life cycle by connecting stakeholders utilizing an analysis for identifying best stakeholder matches and facilitating innovation transactions.

FIG. 2 illustrates an example innovation life cycle via a system platform.

FIG. 3 illustrates an example of device circuitry.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Connecting start-ups, innovators, incubators, universities, and/or the like (referred as “start-ups” for ease of readability) with investors, experts, market leaders, people with market connections, incubators, industry partners, eventual customers, and/or the like (collectively referred to as “innovation accelerators” or “accelerators” for ease of readability) can be very difficult. Even start-ups that have a great product or innovation may never be able to reach an innovation accelerator and may, therefore, be unable to gain a foothold in the market, thereby killing the innovation before it can reach consumers. For the innovation accelerators it can be difficult to determine which innovations are worth investing time, money, or other resources in since it is difficult to predict how commercially successful an innovation might be. Additionally, since the innovation accelerators receive so many requests, the innovation accelerator may have a team that reviews the requests and the accelerator may never see a particular request even if it ends up being a commercial success. There is no current technique for connecting start-ups with accelerators other than the start-up contacting the accelerator. Additionally, there is no technique that provides accelerators with a prediction regarding the commercial success of an innovation. Rather, the accelerators must rely on internal knowledge and predictions based upon internal data.

Accordingly, an embodiment provides a method for facilitating an innovation life cycle by connecting stakeholders utilizing an analysis for identifying best stakeholder matches and facilitating innovation transactions. The described system includes a system platform that is accessible to start-ups and accelerators. The platform receives information corresponding to an innovation from a first stakeholder, which will be referred to as a start-up for ease of readability. The information may identify different attributes, features, supporting documentation, and the like, of the innovation. The platform is able to rank the innovation based upon a likeliness of commercial success or marketplace potential. The likeliness of commercial success or marketplace potential can be determined from a plurality of factors of the innovation that are identified from the information. For example, the platform can identify attributes, features, a marketplace category, supporting documentation, and the like, of the innovation. These factors can be analyzed using an algorithm to rank the innovation.

Based upon the ranking, one or more second stakeholders, referred to as accelerators for each of readability, who are connected with the platform may become interested in the innovation. The accelerator(s) may request an objective evaluation of the innovation from an expert. From this request, or request from a different source, the platform may identify an expert who is suitable for analyzing the innovation. Identifying an expert may be based upon comparing attributes within a profile of the expert to the factors of the innovation to find the expert who may be best suited for performing the objective evaluation. The objective evaluation can be presented to the accelerator. If the accelerator decides to invest in the start-up based upon the innovation, for example, based upon the objective evaluation, the platform can facilitate an innovation transaction between the start-up and the accelerator, thereby resulting in an investment (e.g., equity, time, resources, connections, etc.) from the accelerator to the start-up.

The platform also provides additional features. For example, the platform can facilitate that each stakeholder outside of the innovation transaction but who contributed to the transaction is paid. For example, the platform can facilitate payment to the expert who performed the objective evaluation. Additionally, as each innovation is processed through the platform and each innovation transaction is facilitated, the platform can aggregate information about the innovations and those innovations who receive investments. This information can be used to build deal flow knowledge and statistics which can be used by the platform to generate reports. One such report may include identifying the innovation types that are most desirable to accelerators based upon a frequency of innovations within a particular field and how recently such innovations have been invested within. This may encourage other accelerators to want to invest in an innovation and the platform can facilitate an innovation transaction between these other accelerators and the start-up even after the first innovation transaction has occurred. Thus, the platform attempts to connect stakeholder groups within the life cycle of an innovation by, in part, identifying the best partners in each stakeholder group to nurture the technology to commercialization.

Such a system provides a technical improvement over current techniques for connecting start-ups and accelerators. The described system provides a platform that allows for start-ups and accelerators to connect. Additionally, the platform is able to analyze and rank the innovations which allows for feedback to the start-ups and also allows the accelerators to be apprised of innovations that may show the most promise for commercial success. Such a system provides a much better technique for connecting start-ups and accelerators by making good innovations or innovations having the most marketplace potential to be seen by accelerators, thereby saving time, money, and resources for both the start-ups and the accelerators as compared to conventional techniques.

Additionally, as the platform continually receives innovations and facilitates transactions between start-ups and accelerators, the platform can analyze the information regarding the innovations and innovations that are being invested in to provide reports regarding the field of innovations. For example, based upon a frequency of innovations within a particular field that are being invested within, the platform can identify those fields which are appealing to accelerators. Thus, the described system provides something that is not currently provided within the field, specifically, a platform that connects start-ups with accelerators and is additionally able to analyze information to provide feedback and reports to both the start-ups and accelerators.

The illustrated example embodiments will be best understood by reference to the figures. The following description is intended only by way of example, and simply illustrates certain example embodiments.

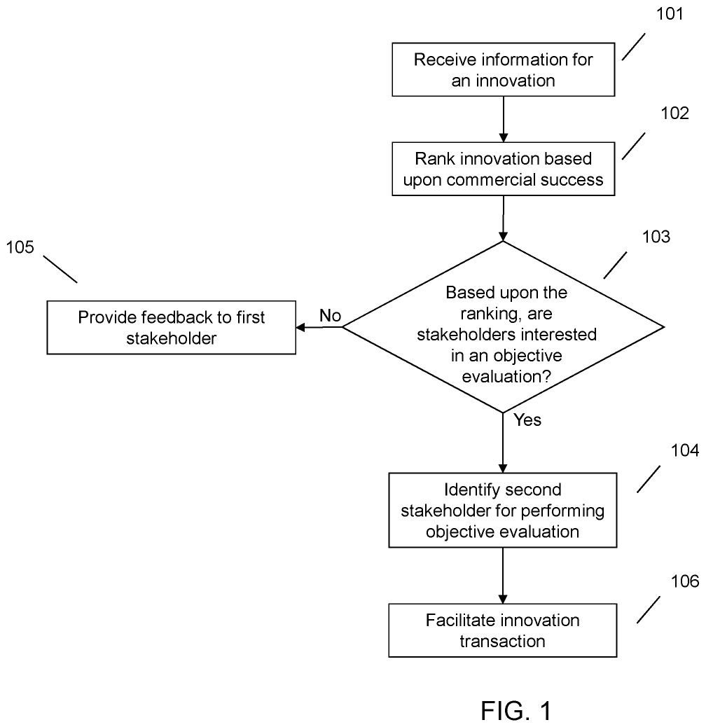

FIG. 1 illustrates a method for facilitating an innovation life cycle by connecting stakeholders utilizing an analysis for identifying best stakeholder matches and facilitating innovation transactions using a system platform. The system may be system platform that allows for stakeholders to connect with each other. The platform and/or platform access point (e.g., graphical user interface, application, etc.) may be provided on any applicable operating platform (e.g., Internet webpage, mobile applications, network application, etc.). The platform may be managed or facilitated by a party that is not a stakeholder within the innovation life cycle. For example, the platform may be managed by a party familiar with an industry, but who is not a start-up, industry expert, and/or accelerator from an innovation life cycle point of view. This provides a neutral party, which may be more appealing to start-ups and accelerators as far as encouraging these stakeholders to be a part of the platform.

The system platform may include a graphical user interface that stakeholders can access to perform different tasks, which may be different depending on the stakeholder. For example, a start-up may access the platform to provide information regarding the innovation that the start-up is attempting to get an investment in. As another example, an accelerator may access the platform to see rankings of innovations, select innovations of interest, and the like. Depending on the role of the stakeholder, the platform may provide different graphical user interfaces so that the stakeholder can access information that is applicable to the role of the stakeholder. Additionally, or alternatively, each stakeholder may be presented with similar information and may then access different areas of the platform in order to perform a desired function.

At 101 the system receives information corresponding to an innovation from a first stakeholder, referred to as a start-up for ease of readability. The start-up may join the platform at any point of the innovation. For example, the start-up may choose to place the innovation on the platform at the time of conception, after receiving an initial funding, at a particular point in marketplace success, after receipt of supporting documentation (e.g., purchase orders, intellectual property protection documents, marketplace test results, etc.). The information may include any information corresponding to the innovation that provides for identifying features, factors, attributes, and/or other information that would assist in identifying the innovation and determining a likelihood of commercial success. Examples of the information that might be received at 101 include a description of the innovation, pictures of the innovation, identification of a current stage of the innovation, any supporting documentation, identification of a market category, or the like. The platform may provide prompts or specific input areas for some types or fields of information. The platform may also provide free-form fields so that the start-up can provide any information that may be useful in assessing the likelihood of commercial success.

From this information, the system platform can rank the innovation based upon a likeliness of commercial success at 102. The likeliness of commercial success or marketplace potential is determined based upon a plurality of factors corresponding to the innovation and identified, at least in part, from the information received at 101. The system platform may utilize an algorithm to perform the ranking. The algorithm may take into account different factors and may also access secondary sources in order to perform the ranking. For example, the system may assess the intellectual property potential of the innovation, influence metrics corresponding to the innovation, journals and publications, innovativeness of the innovation, and the like, to assist in determining the likelihood of commercial success. As a simple example, the system may access journals and/or publications to identify how prominent innovations similar to the presented innovation are within the field. The journals and publications could also be used to identify needs of the market or obstacles of the market category which can influence the ranking of the innovation. As another simple example, the system can assess an intellectual property potential by accessing existing intellectual property documents to determine if a similar innovation has already been protected.

The ranking may be made for the single innovation or may be made against other innovations. In other words, the ranking may simply be a ranking of the innovation on a particular scale with one end of the scale correlating to a low likeliness of commercial success and the other end of the scale correlating to a high likeliness of commercial success. On the other hand, or as an additional ranking, the ranking may be made against other innovations, where each innovation within a batch are analyzed against each other to identify the innovation having the best likeliness of commercial success as compared to other innovations within the batch. Batches may be made based upon different attributes. For example, the system may batch innovations that are within a similar market category. As another example, the system may batch innovations based upon a time that the innovations are provided to the platform. As another example, the system may batch innovations that are within similar stages of innovation. Other batching techniques or combinations thereof are contemplated and possible.

Once the ranking is performed, the ranking information may be made accessible on the platform. This may include providing the ranking back to the start-up, thereby providing a feedback mechanism. The ranking may also include a report identifying the areas which resulted in the ranking. For example, if a particular area caused a low ranking, the start-up may be alerted to this fact. This feedback allows the start-up to modify the innovation if desired. The modified innovation can be provided to the platform and the platform can re-rank the innovation based upon the modifications to the innovations. In modifying the innovation within the platform, the start-up may access the input area corresponding to the innovation and make changes to the innovation within this area, thereby reducing the amount of time and/or input required by the start-up as compared with starting a whole new innovation input session or page.

The ranking may also be provided to or accessible by accelerators. This allows the accelerators to quickly identify those innovations which may be most likely to have commercial success or have marketplace potential. In providing the ranking, the platform may simply provide a rank list or other area within the platform that can be accessed by any accelerator that has signed up with or otherwise accessed the platform. Alternatively, or additionally, the accelerator may create a profile that may identify different innovation features or criteria that are of interest to the accelerator. For example, the accelerator may identify a particular market category that is of interest. As another example, the accelerator may identify a particular innovation stage requirement. The system may use these identified innovation features to provide a targeted list or ranking to the accelerator that includes innovations meeting the desired criteria. Even if the accelerator has provided input regarding innovation features or criteria of interest, this does not preclude the accelerator from having access to information or rankings of innovations not meeting the identified criteria.

The system may determine, at 103, if any stakeholders are interested in an objective evaluation of the innovation, for example, based upon the ranking. This determination may be made based upon feedback received from an accelerator or other source. For example, the start-up may wish to have an objective evaluation performed on the innovation. If no indication is provided to the platform that an objective evaluation is desired, the system may provide feedback to the first stakeholder or start-up at 105. The feedback may include an indication that no accelerator appears to be interested in the innovation. Alternatively, if no indication is received regarding an interest in an objective evaluation, the platform may simply take no further action regarding the innovation.

On the other hand, if the platform receives input indicating that an objective evaluation is desired, the system may identify at least one second stakeholder, referred to as an expert for ease of readability, for performing the objective evaluation of the innovation at 104. Thus, the objective evaluation is an on-demand objective evaluation that is performed in response to receiving an input indicating the objective evaluation has been requested. In identifying an expert, the platform identifies one or more experts who are suitable for analyzing the innovation. The experts may already be a part of or engaged with the platform or the experts may be known in a particular field. In the case that the experts are not already engaged with the platform, the platform may contact the expert requesting engagement with the platform in order to perform the objective evaluation. In identifying an expert, the system may identify more than one expert, thereby allowing the evaluation requestor to select a particular expert. Additionally, or alternatively, the system may identify a group of experts to perform the evaluation. For example, the platform may identify that the innovation covers different fields and may, therefore, be best evaluated by different experts within the different fields.

In identifying one expert, a list of experts, or a grouping of experts (collectively referred to as “expert” for ease of readability), the system may analyze various factors. These factors may be associated with the expert, the innovation, market category, or the like. As an example, the system may access a profile of an expert to identify a background of the expert, field of expertise, feedback regarding previous evaluations, industry view of the expert, qualifications, availability, hourly or fixed rate, keywords, and the like. Some of these attributes may be provided by the expert, while some of the attributes may be determined by the platform, for example, by accessing secondary sources. Additionally, some of the attributes may be public, private to the expert and platform alone, and/or private to the platform itself. Accordingly, the platform may include an area for experts to provide input and information that can be used in an analysis for identifying an expert for performing an evaluation. The platform can identify the expert most capable of analyzing the innovation utilizing an algorithm that can analyze the innovation against the factors of the expert. In other words, the platform can identify the expert suitable for analyzing the innovation based upon correlating attributes within a profile of the expert to the innovation.

Once the objective evaluation is performed, the platform may take an additional step to update a desirability ranking of the innovation based upon the objective evaluation. The desirability ranking of the innovation is a ranking different from the ranking discussed in connection with 102. Rather, the desirability ranking provides an indication of how desirable the start-up or innovation is, as opposed to a likeliness of commercial success. In other words, now that the innovation has had an objective evaluation performed, the innovation may become more desirable, assuming the evaluation is positive, because it now has the support of an expert which may give an accelerator more confidence in the innovation.

Once the objective evaluation is performed, it may be provided to the requestor. In the case that the requestor is a third stakeholder, referred to as an accelerator for ease of readability, and the accelerator is now interested in investing in the start-up based upon the evaluation, the platform can facilitate the innovation transaction between the start-up and the accelerator through or via the platform at 106. In other words, the system can facilitate an innovation transaction in response to the accelerator initiating the innovation transaction. Facilitating the innovation transaction may include providing template documents, for example, term sheets, contracts, and the like, that can be modified by the accelerator to be provided to the start-up through the platform. The accelerator may also be provided with the desirability ranking, which may encourage the accelerator to initiate the innovation transaction. Provision of the desirability ranking may include a notification regarding the desirability ranking.

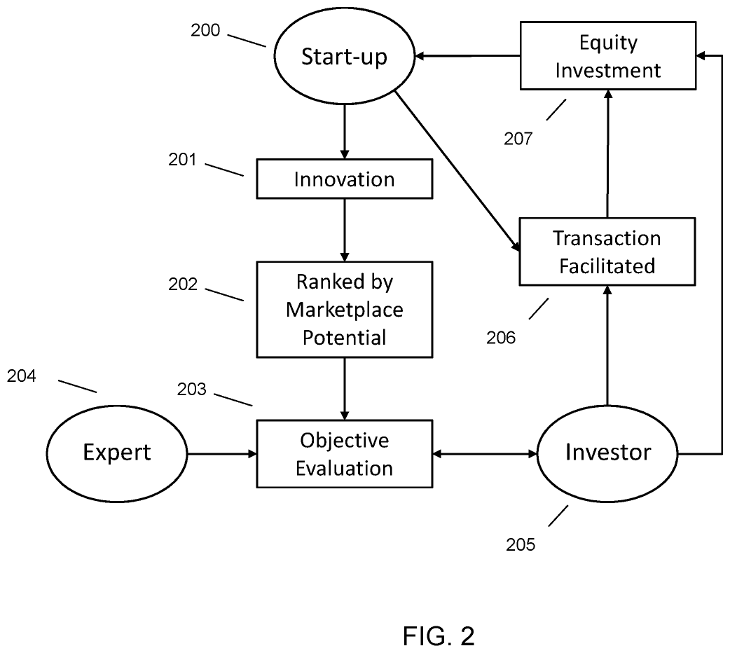

FIG. 2 illustrates an example innovation life cycle facilitated via the system platform described herein. A start-up 200 may provide an innovation 201 to the platform described herein. In providing the innovation 201, the start-up 200 may provide information corresponding to the innovation 201. The platform may then rank the innovation by marketplace potential at 202. If interest is shown by an investor 205, an objective evaluation 203 may be performed by an expert 204. The objective evaluation 203 may be provided to the investor 205. If the investor 205 initiates an innovation transaction, the platform facilitates the transaction at 206 between the start-up 200 and the investor 205. An equity investment 207 may then be made from the investor 205 to the start-up 200.

The system may also perform other functions. For example, the system may facilitate payment of the expert for performing the objective evaluation. By facilitating the payment of the expert through the platform, experts may be more likely to engage with the platform because the expert is confident that payment will be made. Additionally, the platform can facilitate any other payments that are necessary, for example, any fees to the party that manages the platform.

Additionally, the platform can perform additional analysis functions. For example, as more and more innovations are provided to the platform and innovation transactions are facilitated by the platform, the platform can perform analytics on this information to generate deal flow knowledge and/or statistics. In other words, the platform can generate reports that identify focuses of innovations based upon an accumulation of innovation transactions facilitated through the platform. In generating this report the platform can analyze different features of innovations and, based upon the innovations that are chosen for transactions, identify the features that result in transactions. The report may provide a ranking of the focuses of innovations based upon a number of transactions that correspond to a particular focus and a time of occurrence of the transaction. By identifying not only the number of transactions of a particular focus, but also identifying the time of occurrence, the system can identify those innovation features or focus that are “hot” at a particular time. In other words, while a focus may have a large number of transactions, if these transactions occur over a long period of time, this focus may not be considered particular “hot” at the current time.

The platform is also able to facilitate additional innovation transactions either at the same time as the initial innovation transaction or at a subsequent point in time. For example, based upon the deal flow report, or the fact that an innovation transaction has occurred for an innovation, another accelerator may become interested in investing in the innovation. The system can facilitate this second innovation transaction for the innovation using the same techniques as used in facilitating the first innovation transaction.

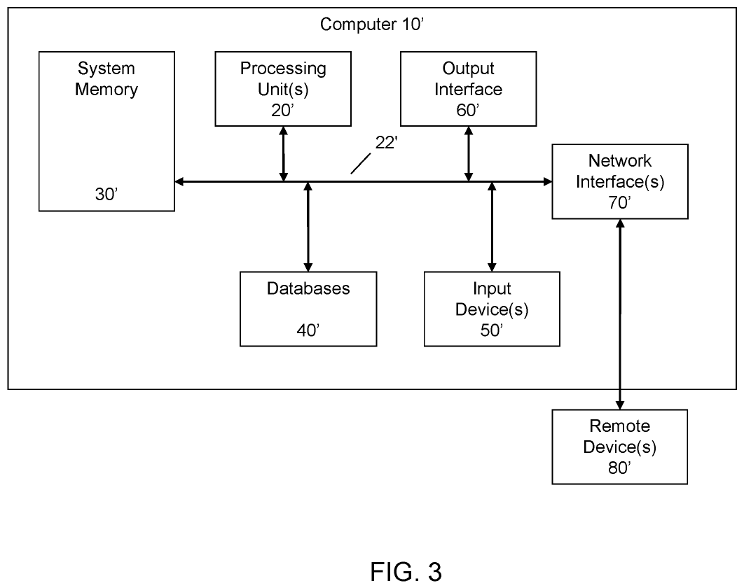

While various other circuits, circuitry or components may be utilized in information handling devices, with a computer, server, client device or the like, an example device that may be used in implementing one or more embodiments includes a computing device in the form of a computer 10′ as illustrated in FIG. 3. This example device may be a server used in one of the systems in a network, or one of the remote computers connected to the network. Components of computer 10′ may include, but are not limited to, a processing unit 20′, a system memory 30′, and a system bus 22′ that couples various system components including the system memory 30′ to the processing unit 20′. Computer 10′ may include or have access to a variety of computer readable media, including databases. The system memory 30′ may include non-signal computer readable storage media, for example in the form of volatile and/or nonvolatile memory such as read only memory (ROM) and/or random access memory (RAM). By way of example, and not limitation, system memory 30′ may also include an operating system, application programs, other program modules, and program data.

A user can interface with (for example, enter commands and information) the computer 10′ through input devices 50′ (e.g., keyboard, soft keyboard, mouse, auditory inputs, haptic inputs, gesture inputs, etc.). A monitor or other type of device can also be connected to the system bus 22′ via an interface, such as an output interface 60′. The computer may include a database 40′. In addition to a monitor, computers may also include other peripheral output devices. The computer 10′ may operate in a networked or distributed environment using logical connections to one or more other remote device(s) 80′ such as other computers. The logical connections may include network interface(s) 70′ to a network, such as a local area network (LAN), a wide area network (WAN), and/or a global computer network, but may also include other networks/buses.

Information handling device circuitry, as for example outlined in FIG. 5, may be used in client devices such as a personal desktop computer, a laptop computer, or smaller devices such as a tablet or a smart phone. In the latter cases, i.e., for a tablet computer and a smart phone, the circuitry outlined in FIG. 5 may be adapted to a system on chip type circuitry. The device, irrespective of the circuitry provided, may provide and receive data to/from another device, e.g., a server or system that coordinates with various other systems. As will be appreciated by one having ordinary skill in the art, other circuitry or additional circuitry from that outlined in the example of FIG. 5 may be employed in various electronic devices that are used in whole or in part to implement the systems, methods and products of the various embodiments described herein.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method for facilitating an innovation life cycle by connecting stakeholders utilizing an analysis for identifying best stakeholder matches and facilitating innovation transactions, the method comprising:
receiving, at a system platform, information corresponding to an innovation from a first stakeholder;
ranking, using the system platform, the innovation based upon a likeliness of commercial success of the innovation, the likeliness being determined based upon a plurality of factors corresponding to the innovation and identified, at least in part, from the information;
identifying, using the system platform, at least one second stakeholder for performing an objective evaluation of the innovation, wherein the at least one second stakeholder comprises an expert suitable for analyzing the innovation; and
facilitating, via the system platform, an innovation transaction between the first stakeholder and at least one third stakeholder, wherein the at least one third stakeholder initiates the innovation transaction in response to receipt of the objective evaluation.

2. The method of claim 1, comprising providing the ranking to the first entity, receiving modifications to the innovation based upon the ranking, and re-ranking the innovation based upon the modifications.

3. The method of claim 1, wherein the ranking comprises analyzing the plurality of factors in view of secondary sources providing an indication of a likelihood of commercial success.

4. The method of claim 1, wherein determining the expert is suitable for analyzing the innovation is based upon correlating attributes within a profile of the expert to the innovation.

5. The method of claim 1, wherein the identifying is responsive to receipt of a user input requesting the objective evaluation.

6. The method of claim 1, wherein the facilitating comprises providing template documents for the innovation transaction.

7. The method of claim 1, comprising updating, based upon the objective evaluation, a desirability ranking of the innovation; and
wherein the at least one third stakeholder is notified of the desirability ranking of the innovation.

8. The method of claim 1, comprising generating a report identifying focuses of innovations based upon an accumulation of innovation transactions facilitated through the system platform.

9. The method of claim 8, wherein the report provides a ranking of the focuses based upon a number of innovation transactions corresponding to a focus and a time of occurrence of the innovation transactions corresponding to a focus.

10. The method of claim 1, comprising facilitating at least one second innovation transaction for the innovation, wherein the at least one second innovation transaction comprises a stakeholder other than the at least one third stakeholder.

11. A system for facilitating an innovation life cycle by connecting stakeholders utilizing an analysis for identifying best stakeholder matches and facilitating innovation transactions, the system comprising:
one or more processors;
a memory device that stores instructions executable by the processor to:
receive, at a system platform, information corresponding to an innovation from a first stakeholder;
rank, using the system platform, the innovation based upon a likeliness of commercial success of the innovation, the likeliness being determined based upon a plurality of factors corresponding to the innovation and identified, at least in part, from the information;
identify, using the system platform, at least one second stakeholder for performing an objective evaluation of the innovation, wherein the at least one second stakeholder comprises an expert suitable for analyzing the innovation; and
facilitate, via the system platform, an innovation transaction between the first stakeholder and at least one third stakeholder, wherein the at least one third stakeholder initiates the innovation transaction in response to receipt of the objective evaluation.

12. The system of claim 11, comprising providing the ranking to the first entity, receiving modifications to the innovation based upon the ranking, and re-ranking the innovation based upon the modifications.

13. The system of claim 11, wherein the ranking comprises analyzing the plurality of factors in view of secondary sources providing an indication of a likelihood of commercial success.

14. The system of claim 11, wherein determining the expert is suitable for analyzing the innovation is based upon correlating attributes within a profile of the expert to the innovation.

15. The system of claim 11, wherein the facilitating comprises providing template documents for the innovation transaction.

16. The system of claim 11, comprising updating, based upon the objective evaluation, a desirability ranking of the innovation; and
wherein the at least one third stakeholder is notified of the desirability ranking of the innovation.

17. The system of claim 11, comprising generating a report identifying focuses of innovations based upon an accumulation of innovation transactions facilitated through the system platform.

18. The system of claim 17, wherein the report provides a ranking of the focuses based upon a number of innovation transactions corresponding to a focus and a time of occurrence of the innovation transactions corresponding to a focus.

19. The system of claim 11, comprising facilitating at least one second innovation transaction for the innovation, wherein the at least one second innovation transaction comprises a stakeholder other than the at least one third stakeholder.

20. A product for facilitating an innovation life cycle by connecting stakeholders utilizing an analysis for identifying best stakeholder matches and facilitating innovation transactions, the product comprising:
a storage device that stores code, the code being executable by one or more processors and comprising:
code that receives, at a system platform, information corresponding to an innovation from a first stakeholder;
code that ranks, using the system platform, the innovation based upon a likeliness of commercial success of the innovation, the likeliness being determined based upon a plurality of factors corresponding to the innovation and identified, at least in part, from the information;
code that identifies, using the system platform, at least one second stakeholder for performing an objective evaluation of the innovation, wherein the at least one second stakeholder comprises an expert suitable for analyzing the innovation; and
code that facilitates, via the system platform, an innovation transaction between the first stakeholder and at least one third stakeholder, wherein the at least one third stakeholder initiates the innovation transaction in response to receipt of the objective evaluation.
